(19) United States
(12) Patent Application Publication
(10) Pub. No.: US 2026/0295491 A1
(43) Pub. Date: Oct. 1, 2026

(54) HIGH EFFICIENCY AIR FILTER BODY

(71) Applicant: CORNING INCORPORATED, CORNING, NY (US)

(72) Inventors: Thorsten Rolf Boger, Bad Camberg (DE); Ryoko Chijiiwa, Yokohama-shi (JP)

(21) Appl. No.: 19/478,675

(22) PCT Filed: Apr. 4, 2024
(86) PCT No.: PCT/US2024/022915

§ 371 Date: Oct. 24, 2025

Related U.S. Application Data
(60) Provisional application No. 63/462,070, filed on Apr. 26, 2023.
(60) Provisional application No. 63/523,241, filed on Jun. 26, 2023.

(51) Int. Cl. B01D 46/24; B60H 3/06

(52) U.S. Cl. CPC B01D 46/2484; B01D 46/2429; B01D 46/24491; B01D 46/24492; B01D 46/2455; B01D 46/2459; B01D 46/247; B01D 46/2474; B01D 46/2482; B60H 3/0658

(57) ABSTRACT

Particulate filters comprising a honeycomb structure for cabin air filtration. The honeycomb-structured particulate filter body has a low L/D ratio, high cell density, thin cell wall, high porosity, large median pore diameter, and preferably short plugs and optional deposited material disposed in the honeycomb structure.

### CROSS REFERENCE TO RELATED APPLICATION

This application claims the benefit of priority under 35 U.S.C. § 119 of U.S. Provisional Application Ser. No. 63/523,241 filed on, Jun. 26, 2023, and U.S. Provisional Application Ser. No. 63/462,070 filed on Apr. 26, 2023, the content of which is relied upon and incorporated herein by reference in its entirety.

### TECHNICAL FIELD

Embodiments of the present disclosure generally relate to articles and methods for filtering particulate matter from air with porous honeycomb structures, and the filter bodies having the inorganic deposits on its interior walls.

### BACKGROUND

Air filters for the interior of vehicles such as a cabin air filter is used to improve the air quality inside the vehicle or car. The filter is located upstream of the air conditioning unit and in cars is often found behind a glove box or dashboard. Because the air flow rate through and from the air conditioning system is directly affected by the pressure drop of the filter upstream of the air conditioner, the back pressure must be managed. Typically the filter should be regularly replaced. Existing cabin air filters are made of several fiber layers which may be corrugated. Although various cabin air filters have a very high filtration efficiency solution using a HEPA filter, such filters also have very high back pressure penalty.

### SUMMARY

In one or more aspects, a particulate filter body is disclosed comprising a honeycomb structure comprised of a matrix of intersecting porous cell walls extending in an axial direction between an inlet end and an outlet end and forming a plurality of cells comprising wall surfaces which define axial channels, wherein a length L of the honeycomb structure extends from the inlet end to the outlet end, wherein a transverse area A of the honeycomb structure at the inlet end which is perpendicular to the axial direction has an equivalent diameter Deq=2×A/π, wherein the honeycomb structure has an L/Deq ratio of less than 0.30, wherein the honeycomb body comprises a cell density greater than or equal to 200 cpsi, for example 200 to 400 cpsi, or greater than 250 cpsi, such as 250 to 350 cpsi, or 270 to 330 cpsi, or greater than or equal to 200 cpsi and less than or equal to 900 cpsi, or 200 to 800 cpsi, or 200 to 700 cpsi, or 250 to 650 cpsi, and wherein the porous cell walls have an average thickness of less than or equal to 7.0 mil, such as less than or equal to 6.5 mil, or ≤6.0 mil, or ≤5.5 mil, or ≤5.0 mil, a median pore diameter D50 of greater than 10.0 μm, and an average porosity of greater than 50%.

In embodiments, at least some of the cells are sealed with plugs at or near either the inlet end or the outlet end. In embodiments, the plugs have an average axial length of less than or equal to 4.0 mm, or less than or equal to 3.5 mm, or less than or equal to 3.0 mm, or less or equal to than 2.5 mm, or less than or equal to 2.0 mm, or less than or equal to 1.5 mm, or less than or equal to 1.0 mm, or less than or equal to 0.5 mm, such as in the range of 0.5 mm to 4.0 mm, or 0.5 to 4.0 mm, or 1.0 to 4.0 mm, or 1.0 to 3.0 mm. In embodiments, the plugs are disposed in a plugging pattern which causes gas to pass through at least some of the porous walls.

In embodiments, a first subset of the channels are plugged near the outlet end and are open at or near the inlet end, and a second subset of the channels are plugged near the inlet end and are open at or near the outlet end.

In embodiments, at least some of the porous cell walls support deposited material which is different from a material of the porous cell walls.

In embodiments, at least some of the porous cell walls support inorganic filtration deposits. In one or more aspects, the inorganic filtration deposits comprise one or more metal oxide, such as alumina, silica, or copper oxide, and/or one or more metal carbide such as silicon carbide, and/or one or more zeolite. The inorganic filtration deposits may comprise a metal or metal-containing material, such as a copper-containing compound or material or silver-containing compound or material, such as an antiviral and/or antibacterial agent. The inorganic filtration deposits may comprise a catalyst material or catalyst host material, such as a zeolite.

In embodiments, the inorganic filtration deposits are comprised of particles, agglomerates, and/or aggregates of alumina, silica, cordierite, silicon carbide, or combinations thereof.

In embodiments, the honeycomb structure further comprises inorganic filtration material disposed on, in, or both on and in, at least some of the cell walls.

In embodiments, the honeycomb structure further comprises antibacterial material disposed on, in, or both on and in, at least some of the cell walls.

In embodiments, the honeycomb structure further comprises antiviral material disposed on, in, or both on and in, at least some of the cell walls.

In embodiments, the honeycomb structure further comprises odor reduction material disposed on, in, or both on and in, at least some of the cell walls, and in some aspects the cell walls may be comprised of carbon or activated carbon or both carbon and activated carbon. In embodiments, the honeycomb structure further comprises activated carbon disposed on, in, or both on and in, at least some of the cell walls, and in some aspects the cell walls may be comprised of carbon or activated carbon or both carbon and activated carbon. In embodiments, the honeycomb structure further comprises one or more zeolites disposed on, in, or both on and in, at least some of the cell walls.

In embodiments, the porous cell walls have an average porosity of greater than 55%. In embodiments, the porous cell walls have an average porosity of greater than 60%. In embodiments, the porous cell walls have an average porosity of greater than 65%.

In embodiments, the honeycomb body comprises a cell density greater than 350 cpsi. In embodiments, the honeycomb body comprises a cell density greater than 400 cpsi. In embodiments, the honeycomb body comprises a cell density greater than 500 cpsi. In embodiments, the honeycomb body comprises a cell density greater than 600 cpsi. In embodiments, the honeycomb body comprises a cell density greater than 700 cpsi.

In one or more aspects, a method is disclosed herein of filtering cabin air of a vehicle, the method comprising forcing air through a honeycomb-structured filter body, the filter body comprising a honeycomb structure comprised of a matrix of intersecting porous cell walls extending in an axial direction between an inlet end and an outlet end and forming a plurality of cells comprising wall surfaces which define axial channels, wherein a length L of the honeycomb structure extends from the inlet end to the outlet end, wherein a transverse area A of the honeycomb structure at the inlet end which is perpendicular to the axial direction has an equivalent diameter Deq=2×A/π, wherein the honeycomb structure has an L/Deq ratio of less than 0.30, wherein the honeycomb body comprises a cell density greater than or equal to 200 cpsi, for example 200 to 400 cpsi, or greater than 250 cpsi, such as 250 to 350 cpsi, or 270 to 330 cpsi, or greater than or equal to 200 cpsi and less than or equal to 900 cpsi, or 200 to 800 cpsi, or 200 to 700 cpsi, or 250 to 650 cpsi, and wherein the porous cell walls have an average thickness of less than or equal to 7.0 mil, such as less than or equal to 6.5 mil, or ≤6.0 mil, or ≤5.5 mil, or ≤5.0 mil, a median pore diameter D50 of greater than 10.0 μm, and an average porosity of greater than 50%.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 schematically illustrates in perspective view a portion of a known cabin air filter in the form of a fabric filter with a folded fabric structures embodiment of an apparatus disclosed herein.

FIG. 2 schematically illustrates a side elevational view of a portion of the folded fabric filter of FIG. 1.

FIG. 3 shows back pressure sensitivity with respect to cell density, wherein the calculated pressure drop (in kPa) across honeycomb-structured filter bodies at a space velocity of 0.114 [l/h].

FIG. 4 shows the pressure drop sensitivity to the plug length for a cabin air filter body with the same geometry as the cabin air filter of FIG. 3, that is filter bodies having 200 cpsi and 8.5 mil walls (webs), with one having 55% porosity walls (circles) the other having 65% porosity walls, each with 5 g/L inorganic filtration material, or filtration deposits (f.d.).

FIG. 5 shows simulated back pressure values and effective filtration areas for various filter bodies comprising different cell density and web thickness.

FIG. 6 shows another calculated assessment on the filtration efficiency and back pressure for a 55% porosity filter body and a 55% porosity filter body, both with and without a filtration membrane or filtration deposits, as well as high cpsi (600 cpsi) filter bodies, both with and without a filtration membrane or filtration deposits, for the cabin air filter in comparison to conventional cabin air filters and HEPA filters.

### DETAILED DESCRIPTION

Before describing several exemplary embodiments of the disclosure, it is to be understood that the disclosure is not limited to the details of construction or process steps set forth in the following description. The disclosure is capable of other embodiments and of being practiced or being carried out in various ways.

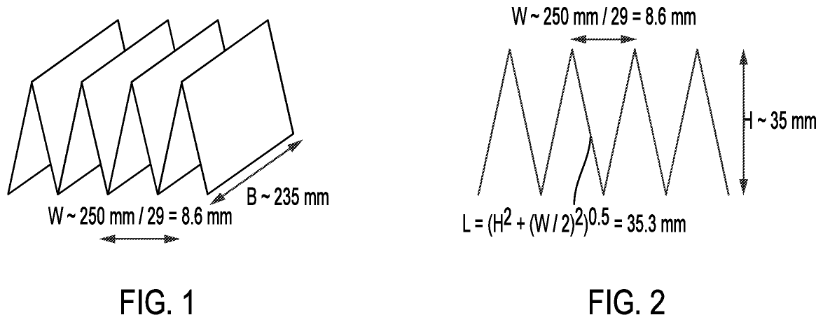

Known cabin air filters such as fabric filters comprising folded fabric structures are schematically illustrated in FIG. 1 in perspective view and FIG. 2 in a side elevational view. One example of such cabin air filter has 29 folds or ridges with an overall width of 250 mm (with the width between folds of 250 mm/29=8.6 mm), an overall height of 35 mm (with a an inclined length from an upper fold or ridge to a lower fold or ridge of 35.3 mm, an overall fold breadth B of 235 mm, and a filtration area Af=29×(235 mm×2×35.3 mm)=0.48 m², or about 0.5 m². The air (e.g. particulate laden air) or gas flow enters these V-shaped spaces and then passes through the filter layers, then exits via the V-shaped spaces on the opposite end. The geometric filtration surface area of such a filter design is very limited. The filter has about 29 “ridges” over a width of ca. 250 mm. The height of the filter is ~35 mm, and the breadth is ~235 mm.

Instead of the conventional fabric filters comprising folded fabric structures for example as illustrated in FIGS. 1 and 2, we disclose a particulate filter comprising a honeycomb structure for cabin air filtration. The honeycomb-structured particulate filter preferably comprises a honeycomb filter body comprising a ratio between its axial length and an equivalent transverse diameter having equivalent frontal area of L/Deq<0.3. The honeycomb filter body preferably has a high cell density (greater than or equal to 200 cpsi, for example 200 to 400 cpsi, or greater than 250 cpsi, such as 250 to 350 cpsi, or 270 to 330 cpsi, or greater than or equal to 200 cpsi and less than or equal to 900 cpsi, such as 200 to 800 cpsi, or 200 to 700 cpsi, or 250 to 650 cpsi), thin cell wall (“web”) thickness (less than or equal to 7.0 mil, such as less than or equal to 6.5 mil, or ≤6.0 mil, or ≤5.5 mil, or ≤5.0 mil) of intersecting porous cell walls, high average wall porosity (>50%), large median pore diameter D50 (>10 μm). The honeycomb structure comprises a plurality of plugs, for example with some plugs disposed at one end (inlet end) and some plugs disposed at the axially or longitudinally opposite end (outlet end), preferably present at one or both ends in a plugging pattern which results in gas or air flow being able to pass through (or be forced through) at least some porous walls that make up the honeycomb structure. In some preferred embodiments, the plugs (or seals) are relatively short plugs (average plug length <4 mm).

In embodiments, the honeycomb structure (or matrix of intersecting walls) is comprised of one or more of a porous material, such as ceramic, glass, polymer, or mixtures thereof.

In embodiments, the honeycomb structure may further comprise one or more materials which provide an odor reduction function, such as activated carbon, or zeolite.

In embodiments, the honeycomb structure may further comprise one or more materials which provide an antibacterial and/or antiviral function.

In embodiments, the honeycomb structure may further comprise inorganic filtration deposits disposed on, in, or both on and in, the walls of the honeycomb, and may be present on surfaces defining pores at the wall surface and/or within the walls.

In embodiments, a filter body comprising a honeycomb structure comprised of porous ceramic walls can be used. We have found that while the filter bodies disclosed herein may be similar in some respects to known honeycomb structured particulate filter bodies, there are however significant and surprising differences between the filter bodies disclosed herein and the known filter bodies. For example, such known filter bodies are made for exhaust aftertreatment applications for diesel or gasoline engines, and so can have lengths of about 100-150 mm and a L/D ratio in the range of 0.6-1.4. We have found that the honeycomb filter body for cabin air filtration needs to fit into existing, defined spaces in terms of dimensions and needs to provide acceptable back pressure performance. For example, in embodiments, the filter body may be rectangular with a short height of 30 to 40 mm and have a representative L/D ratio of 0.1-0.15.

When describing the inlet face of known cabin air filters, for example as shown FIGS. 1 and 2, which are rectangular, an equivalent diameter D is determined, providing the same frontal face area. This significant difference in L/D ratio for cabin air filters vs. conventional honeycomb based particulate filters yields a surprising result with respect to the cell density for honeycomb structured filter bodies for cabin air filtration.

For particulate filters used in aftertreatment applications today the highest cell density is about 350 cpsi, and often such filter bodies have cell densities of 200 to 300 cpsi.

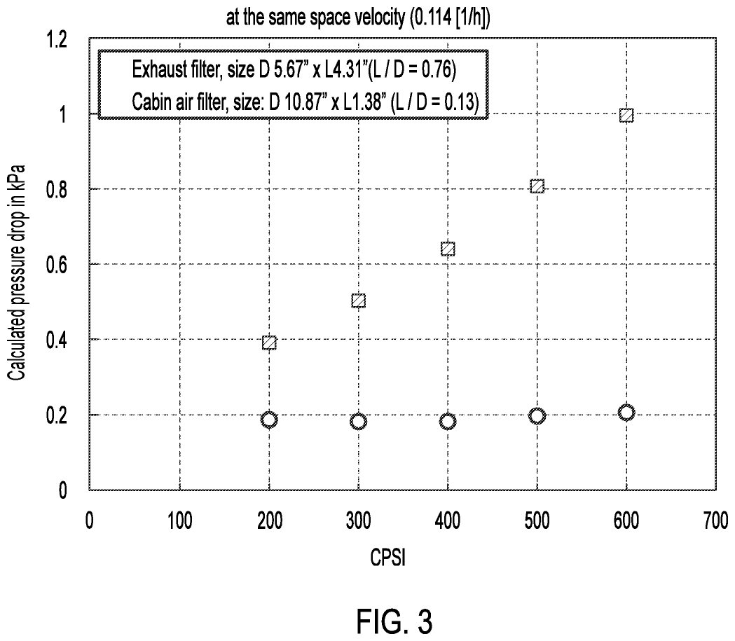

FIG. 3 shows back pressure sensitivity with respect to cell density, wherein the calculated pressure drop (in kPa) across a known honeycomb-structured exhaust filter body (squares) and a cabin air honeycomb-structured filter body disclosed herein (circles) for various cell densities (in cells per square inch, cpsi) at the same space velocity of 0.114 [l/h]. The known filter body had a diameter D of 5.67 inches and a length L of 4.31 inches, and L/D=0.76. The filter body disclosed herein had a diameter D of 10.87 inches and a length L of 1.38 inches, and L/D=0.13. The wall (web) thickness of the matrix cell walls was 8.5 mil for each.

Without needing to be bound by theory, we believe the filter bodies perform in the above manner is that with increasing cell density the frictional losses along the channels start to dominate the pressure drop, as is shown in FIG. 3 for the known “exhaust filter” (blue square symbols). On the other hand, for cabin air filters, a geometry with very short length is needed, which changes this significantly, as is shown in FIG. 3 with the orange circle symbols.

FIG. 3 shows that the increase in cpsi does not affect the back pressure nearly as much in the cabin air filter body as compared to the exhaust aftertreatment filter body. In embodiments disclosed herein, high cell densities may be utilized without incurring an excessively high pressure drop penalty.

Furthermore, we have surprisingly found that relatively short plug lengths may be preferred for such short cabin air filters.

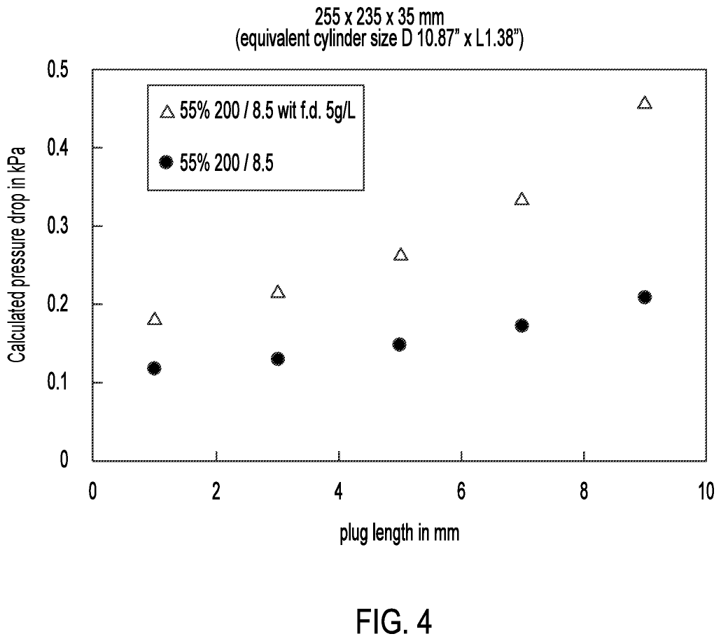

FIG. 4 shows the pressure drop sensitivity to the plug length for a cabin air filter body with the same geometry as the cabin air filter of FIG. 3, that is filter bodies having 200 cpsi and 8.5 mil walls (webs), with one having 55% porosity walls (circles) the other having 65% porosity walls plus 5 g/L inorganic filtration material deposited on the inlet walls of its honeycomb matrix.

As seen in FIG. 4, we have surprisingly found that shorter plug lengths are advantageous for the honeycomb-structured cabin air filter body, here about 2 to 3 mm in length extending into the cells, increasing for longer plug lengths (plug depth), with up to 40% greater pressure drop at the longest plug length of 9 mm for the 55% porosity wall structure as compared to plug lengths of 2 to 3 mm, and with up to 250% greater pressure drop at the longest plug length of 9 mm for the 65% porosity wall structure as compared to plug lengths of 2 to 3 mm.

In some embodiments, the honeycomb-structured filter body comprises plugged channels, the body comprising short plugs, such as plugs of less than about 3.0 mm, and high cpsi, such as >200 cpsi, or >250 cpsi, or greater than or equal to 300 cpsi, or even >400 cpsi, >450 cpsi, >500 cpsi, >600 cpsi, >700 cpsi, or even greater than 800 cpsi, such as greater than or equal to 200 cpsi and less than or equal to 900 cpsi, or 200 to 800 cpsi, or 200 to 700 cpsi, or 250 to 650 cpsi to provide low back pressure while maintaining large filtration area for such short filter.

High filtration efficiencies may be provided by smaller pore size (e.g. D50) in the cell walls and by thick walls or webs. However, both smaller pore size and thicker walls also increase the resistance to flow, and so the pressure drop. A filter body comprising a hierarchical pore structure, such as a very thin membrane or layer or deposits of inorganic filtration material on or in or both on and in the walls of the cellular structure, can provide minimal impact on the resistance to flow, yet also provide very high filtration efficiency. Accordingly, the dependent effects of filter wall thickness and/or pore size on the filtration efficiency of the filter body can be reduced. For example, the filter web thickness does not need to be thick to have a high filtration efficiency if a hierarchical pore structure is present. A rather thin web thickness may be sufficient to support a membrane or layer or filtration deposits and also have a minimal added back pressure penalty at the same time.

Accordingly, we have found that various embodiments of a filter body can be provided which has a large filtration area with very competitive back pressure, particularly if one or more, and preferably all, of these characteristics are provided: short plugs, high cpsi, thin web thickness and an inorganic filtration layer.

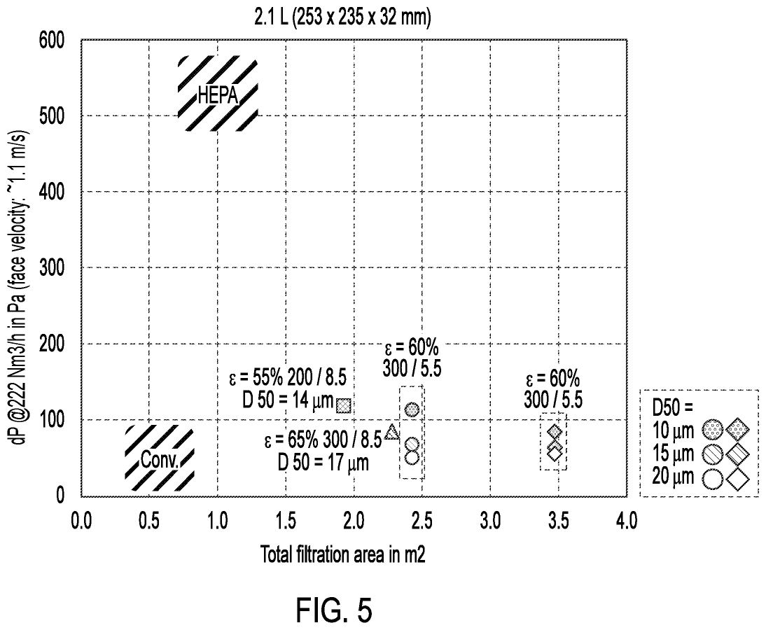

FIG. 5 shows simulated back pressure values and effective filtration areas for various filter bodies comprising different cell density and web thickness. Honeycomb designs with 600/3.5 and 300/5.5 are produced as flow through substrates in Corning's high porosity substrates development, demonstrating that such structures can be produced with very high porosity (~60-65%) bodies in sufficient mechanical strength.

As seen in FIG. 5, the range of back pressure and filtration area for the conventional cabin air filters (square at the bottom left) are shown with generally 0.4 to 0.8 m² total filtration area exhibiting a pressure drop dP of 10 to 90 Pa. The range of back pressure and filtration area for HEPA filters (square at the top left) are shown with generally 0.75 to 1.25 m² total filtration area exhibiting a much higher pressure drop dP of 480 to 580 Pa, i.e. about 40 to 60 times the pressure drop of the conventional air filters. On the other hand, the high cpsi and thin web thickness filter bodies disclosed herein could achieve three to seven times larger filtration area compared to the conventional ones, while maintaining the back pressure almost in a same level, even without a filtration membrane or layer. The higher available filtration area is expected to provide an advantage in terms of lifetime of the cabin air filtrations applications where normally filters need to be regularly replaced.

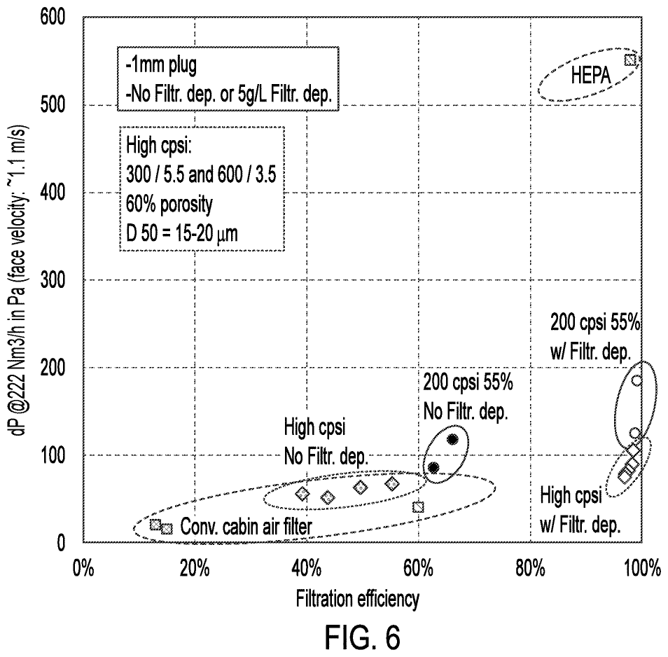

FIG. 6 shows another calculated assessment on the filtration efficiency and back pressure for a 55% porosity filter body and a 55% porosity filter body, both with and without a filtration membrane or filtration deposits, as well as high cpsi (600 cpsi) filter bodies, both with and without a filtration membrane or filtration deposits, for the cabin air filter in comparison to conventional cabin air filters and HEPA filters. The back pressure at 1.1 m/s of face velocity with and without filtration layer were simulated, and the filtration efficiency was calculated using an FPM (smoke FE) calculator. The filtration layer provides high filtration efficiency, although the layer adds some back pressure penalty on the filter body. Filter layer penetration depth was estimated to be about the same for the lower porosity and higher porosity honeycomb structures.

As seen in FIG. 6, the high cpsi, thin web, filtration layer filter bodies are competitive to the conventional filters in pressure drop but with much high filtration efficiency, and to the HEPA filter with much lower pressure drop.

Although some of the embodiments discussed above correspond to honeycomb filter bodies made of high temperature porous ceramics, embodiments may instead be comprised of lower temperature materials because cabin air filtration applications may not necessarily require a high temperature material. In many cases today, the air to be treated or filtered will be at temperatures below 100° C. However, in some embodiments and/or application, periodic heat treatments for disinfection and odor prevention may require the filter to sustain somewhat higher temperatures during those processes.

Antibacterial or antiviral functionality may be provided by the selection of suitable powder materials for the filtration material or membrane deposition process, or by coating or impregnating the inorganic filtration particles with active agents prior to or during deposition. For example, activated carbon could be deposited along with the inorganic particles for forming a membrane or layer or filtration deposits with added functionality.

Advantageously, another feature of the filter bodies disclosed herein is the capacity to be easily cleaned and/or a long filter life. The significantly higher filtration area mentioned above is expected to provide even by itself a significant improvement in filter life as there is much more area available for the collected particles to accumulate. Also, the filtration membrane or filtration deposits may prevent particles removed from the air to penetrate the microstructure of the filter body, which would otherwise result in a more pronounced increase in pressure drop per amount of collected material. Moreover, embodiments of the filter bodies disclosed herein may be easily cleaned using for example a brush to remove large particles from the frontal face, as the high cell density results in a very fine grid of very small channels which act essentially as a screen for particles, for example in the range of >0.5 mm. Also, particles collected inside the channels may be easily removed by air blowing from the back side. If hot air, e.g. at temperatures >80° C., is used this would also provide for some disinfection and help to reduce the buildup of odor. Alternatively to the blowing with air, it may also be possible to clean the filter using liquids such a water and water with detergents.

To evaluate the filtration efficiency of the particulate filter comprising inorganic deposits, one FE test is a Smoke FE test using smoke particles or nanoparticles and the pressure drop across a filter can be measured at different flow rates, even without loading soot into or onto the filter part. The term “clean” refers to a zero soot loading or no soot loading. Unless otherwise noted, a soot loaded backpressure is measured at one flow rate (generally 357 Nm³/hr). Procedures are described below for the “Smoke filtration efficiency test”.

A “smoke test” or “smoke FE test”, was conducted as follows. 300 nm median cigarette smoke particulate was used to measure the filtration efficiency. The upstream concentrations were 500,000 particles over 30 seconds which is equal to approximately 353 particles/cc with a 0.1 cfm flow rate into a Lighthouse Handheld 3016 particle counter. The particle number was collected for 30 seconds upstream and downstream simultaneously with two particle counters. The air velocity was 51 m³/h. The filtration efficiency was calculated based on reduction of particulate number concentration at downstream. The pressure drop was measured at the same flow rate by differential pressure gauge. Such smoke FE test could be used to evaluate FE before and after durability testing, and thus provide a measure of the durability of the filtration deposits. Such smoke FE test could thus be used before and after durability testing of a filter part.

Reference throughout this specification to “one embodiment,” “certain embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in one embodiment” or “in an embodiment” in various places throughout this specification are not necessarily referring to the same embodiment of the disclosure. Furthermore, the particular features, structures, materials, or characteristics may be combined in any suitable manner in one or more embodiments.

Although the disclosure herein has been described with reference to particular embodiments, those skilled in the art will understand that the embodiments described are merely illustrative of the principles and applications of the present disclosure. It will be apparent to those skilled in the art that various modifications and variations can be made to the method and apparatus of the present disclosure without departing from the spirit and scope of the disclosure. Thus, the present disclosure can include modifications and variations that are within the scope of the appended claims and their equivalents.

1. A particulate filter body comprising:
a honeycomb structure comprised of a matrix of intersecting porous cell walls extending in an axial direction between an inlet end and an outlet end and forming a plurality of cells comprising wall surfaces which define axial channels;
wherein a length L of the honeycomb structure extends from the inlet end to the outlet end;
wherein a transverse area A of the honeycomb structure at the inlet end which is perpendicular to the axial direction has an equivalent diameter Deq=2×A/π;
wherein the honeycomb structure has an L/Deq ratio of less than 0.30;
wherein the honeycomb body comprises a cell density greater than or equal to 250 cpsi; and
wherein the porous cell walls have an average thickness of less than or equal to 7.0 mil, a median pore diameter D50 of greater than 10.0 μm, and an average porosity of greater than 50%.

2. The particulate filter body of claim 1 wherein at least some of the cells are sealed with plugs at or near either the inlet end or the outlet end.

3. The particulate filter body of claim 2 wherein the plugs have an average axial length of less than or equal to 4 mm.

4. The particulate filter body of claim 2 wherein the plugs are disposed in a plugging pattern which causes gas to pass through at least some of the porous walls.

5. The particulate filter body of claim 1 wherein a first subset of the channels are plugged near the outlet end and are open at or near the inlet end, and a second subset of the channels are plugged near the inlet end and are open at or near the outlet end.

6. The particulate filter body of claim 1 wherein at least some of the porous cell walls support deposited material which is different from a material of the porous cell walls.

7. The particulate filter body of claim 1 wherein at least some of the porous cell walls support inorganic filtration deposits.

8. The particulate filter body of claim 7 wherein the inorganic filtration deposits are comprised of particles, agglomerates, and/or aggregates of alumina, silica, cordierite, silicon carbide, or combinations thereof.

9. The particulate filter body of claim 1 wherein the honeycomb structure further comprises at least one of: inorganic filtration material; antibacterial material; antiviral material; odor reduction material; activated carbon material; zeolites material; and combinations thereof, disposed on, in, or both on and in, at least some of the cell walls.

10.-14. (canceled)

15. The particulate filter body of claim 1 wherein the porous cell walls have an average porosity of greater than 55%.

16. (canceled)

17. The particulate filter body of claim 1 wherein the porous cell walls have an average porosity of greater than 65%.

18. The particulate filter body of claim 1 wherein the honeycomb body comprises a cell density greater than 350 cpsi.

19. (canceled)

20. The particulate filter body of claim 1 wherein the honeycomb body comprises a cell density greater than 500 cpsi.

21. The particulate filter body of claim 1 wherein the honeycomb body comprises a cell density greater than 600 cpsi.

22. The particulate filter body of claim 1 wherein the honeycomb body comprises a cell density greater than 700 cpsi.

23. The particulate filter body of claim 1 wherein the porous cell walls have an average thickness of less than or equal to 6.5 mil.

24. (canceled)

25. (canceled)

26. The particulate filter body of claim 1 wherein the porous cell walls have an average thickness of less than or equal to 5.0 mil.

27.-34. (canceled)

35. The particulate filter body of claim 1 wherein the plugs have an average axial length in the range of 0.5 to 4.0 mm.

36. (canceled)

37. The particulate filter body of claim 1 wherein the plugs have an average axial length in the range of 1.0 to 3.0 mm.

38. A method of filtering cabin air of a vehicle, the method comprising:
forcing air through a honeycomb-structured filter body, the filter body comprising a honeycomb structure comprised of a matrix of intersecting porous cell walls extending in an axial direction between an inlet end and an outlet end and forming a plurality of cells comprising wall surfaces which define axial channels;
wherein a length L of the honeycomb structure extends from the inlet end to the outlet end;
wherein a transverse area A of the honeycomb structure at the inlet end which is perpendicular to the axial direction has an equivalent diameter Deq=2×A/π;
wherein the honeycomb structure has an L/Deq ratio of less than 0.30;
wherein the honeycomb body comprises a cell density greater than 200 cpsi; and
wherein the porous cell walls have an average thickness of less than or equal to 7.0 mil, a median pore diameter D50 of greater than 10 μm, and an average porosity of greater than 50%.
